(19) United States
(12) Patent Application Publication
(10) Pub. No.: US 2026/0004505 A1
(43) Pub. Date: Jan. 1, 2026

(54) ACCELERATION OF PRIMITIVE ID MAPPING

(71) Applicants: ATI TECHNOLOGIES ULC, MARKHAM (CA); ADVANCED MICRO DEVICES, INC., Santa Clara, CA (US)

(72) Inventors: Guennadi Riguer, US, CA (US); Michal Wozniak, Koszalin (PL)

(21) Appl. No.: 18/757,731

(22) Filed: Jun. 28, 2024

(51) Int. Cl. G06T 15/04; G06T 7/12; G06T 15/00; G06T 17/20

(52) U.S. Cl. CPC G06T 15/04; G06T 7/12; G06T 15/005; G06T 17/20

(57) ABSTRACT

Techniques for efficiently managing and rendering graphical primitives in three-dimensional (3D) objects are disclosed. A surface of a 3D object is partitioned into a plurality of clusters, each containing a quantity of graphical primitives. Each cluster is mapped to a respective virtual space, which is then hierarchically partitioned into multiple regions. Partition information for the respective virtual space is encoded based on the hierarchical partitioning, and the surface of the 3D object is rendered for display based on the encoded partition information.

### BACKGROUND

In computer graphics, the rendering of three-dimensional (3D) objects onto a two-dimensional (2D) display involves the conversion of geometric data into pixel information via geometry processing, shading, and rasterization. One challenge in such rendering is the efficient mapping of texture coordinates, also termed UV mapping (named for the U-V coordinate system typically used by that mapping), from 2D textures to 3D surfaces and vice versa. Such mapping is useful, for example, in various graphics operations such as texture baking, ray tracing, and complex shading techniques.

Previous approaches to this problem have included utilizing primitive ID maps, which are structures that store the association between 2D texture coordinates and the corresponding 3D surface primitives. However, these primitive ID maps are associated with various drawbacks, such as significant memory requirements associated with detailed textures and correspondingly large texture maps to avoid loss of fidelity. Additionally, aliasing artifacts—visual distortions typically resulting from inadequate sampling rates—are associated with use of these primitive ID maps. There remains a need for an improved solution that minimizes memory usage and maximizes rendering performance without compromising visual quality.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIGS. 1 and 2 illustrate relationships between an object's geometry, its texture map, its primitive ID map, and topology in the context of mapping 2D texture coordinates to 3D surface primitives.

FIG. 3 illustrates an example of binary space partitioning (BSP) for organizing and managing graphical primitives within the UV space of a primitive ID map.

FIG. 4 illustrates aspects of organizing and managing graphical primitives within a virtual UV space, in accordance with one or more embodiments.

FIG. 5 illustrates aspects of a partitioning and encoding process within an individual cluster-specific virtual UV space of an unwrapped cluster, in accordance with one or more embodiments.

FIG. 6 illustrates an encoding approach used to encode a partitioned cluster-specific UV space, in accordance with one or more embodiments.

FIG. 7 illustrates the use of filtering and extrapolation to mitigate potential aliasing artifacts, in accordance with one or more embodiments.

FIG. 8 is a block diagram of a processing system implementing one or more embodiments.

FIG. 9 is a flow diagram illustrating an operational routine for rendering a surface of a 3D object for display using hierarchical partitioning and encoding techniques described herein, in accordance with one or more embodiments.

### DETAILED DESCRIPTION

A common technique in rendering is UV mapping, where each vertex of a primitive is associated with UV coordinates that map to positions on a two-dimensional (2D) texture. This allows the texture to be wrapped around the three-dimensional (3D) geometry. However, there are scenarios, particularly in advanced rendering techniques, where the reverse mapping is required-mapping from 2D texture space back to the 3D primitive.

In traditional shading, shading computations are tightly coupled with visibility computations, meaning that shading is performed for each pixel as it is processed. In contrast, decoupled shading separates the shading process from the visibility determination process, such as by first determining visibility and then applying shading based on the determined visibility information. This separation can significantly improve performance by reducing redundant shading calculations and allowing for more efficient use of computational resources.

One approach to handle the reverse mapping in decoupled shading is through the use of primitive ID maps. A primitive ID map stores the indices of primitives in a texture, allowing a quick lookup of the primitive corresponding to a point in the 2D texture space. However, primitive ID maps require a high memory footprint to store the indices for all the primitives, especially for high-resolution textures. Additionally, they can introduce aliasing artifacts in which the mapping results in visual defects.

Techniques described herein enable efficient rendering of three-dimensional (3D) objects by employing hierarchical partitioning of virtual spaces corresponding to clusters of graphical primitives, and efficiently encoding partition information representing that hierarchical partitioning scheme. By dividing the surface of a 3D object into multiple clusters, each containing a manageable quantity of graphical primitives, the methods facilitate optimized organization and processing. The use of virtual spaces for each cluster allows for structured partitioning, which is hierarchically encoded to capture the structure and boundaries of the partitions. This encoded partition information significantly reduces memory usage and improves rendering speed, as it provides a compact representation of the partitioned virtual spaces.

Furthermore, the hierarchical encoding techniques described herein allow for accurate traversal and shading computations during the rendering process. The efficient encoding scheme ensures that the graphical primitives are accurately assigned to their respective regions within the virtual spaces, minimizing aliasing artifacts and rendering inaccuracies. The methods also support the use of quantized coordinate systems, which further improves encoding efficiency by reducing the required storage for partition information.

In traditional rendering pipelines, shading calculations are generally linked with geometry processing, often leading to a direct one-to-one correlation between pixels on a display device and geometric details of the scene being rendered on that display device. Values for each pixel typically are individually shaded based on the associated underlying geometry, which can be computationally intensive, especially with complex materials or sophisticated lighting effects.

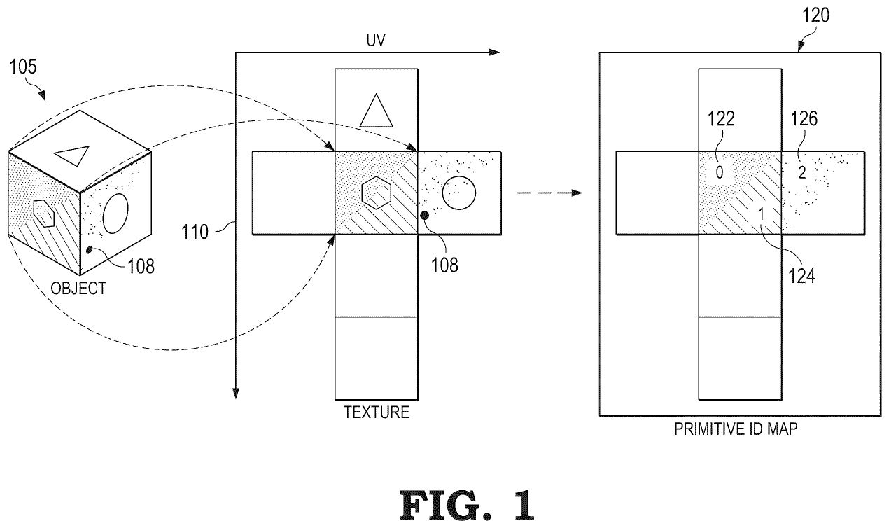

FIG. 1 illustrates the relationship between an object's geometry, its texture map, and a primitive ID map in the context of mapping 2D texture coordinates to 3D surface primitives.

On the left of FIG. 1, a 3D cube object 105 displays various graphical shapes on its three visible sides. It exists within a 3D space, defined by an x, y, and z coordinate system. A specific point on this cube, identified as point 108, is marked for reference and defined by its x, y, z coordinates in this 3D space.

A 2D texture map 110 shows all six sides of the cube object 105 as an unfolded 2D plane, arranged in a cross formation. This 2D representation operates within a planar UV coordinate system, such that ‘U’ and ‘V’ represent the axes of the 2D texture space. These UV coordinates are used to map textures onto 3D objects such as the cube object 105, with each point on the texture map corresponding to a point on the object's surface. Primitives 122, 124, and 126 are illustratively added to the texture map 110, dividing the space corresponding to the cube's faces. Primitive 126, in particular, occupies half of a square panel on the surface of the cube object 105, with point 108 falling within the area of that primitive 126 in terms of UV coordinates.

On the right-hand side of FIG. 1, a primitive ID map 120 connects the cube object 105 in its 3D space with the texture map 110 in the 2D UV space. The primitive ID map 120 functions as a reference system that correlates 2D points on the texture map to specific 3D primitives on the cube object 105. In this representation, the graphical elements from the cube object 105 are not displayed, focusing instead on the primitives 122, 124, and 126 (respectively identified as triangle 0, 1, and 2). These identifiers (and the primitive ID map as a whole) serve to link specific portions of the texture map to corresponding surface primitives on the cube object 105.

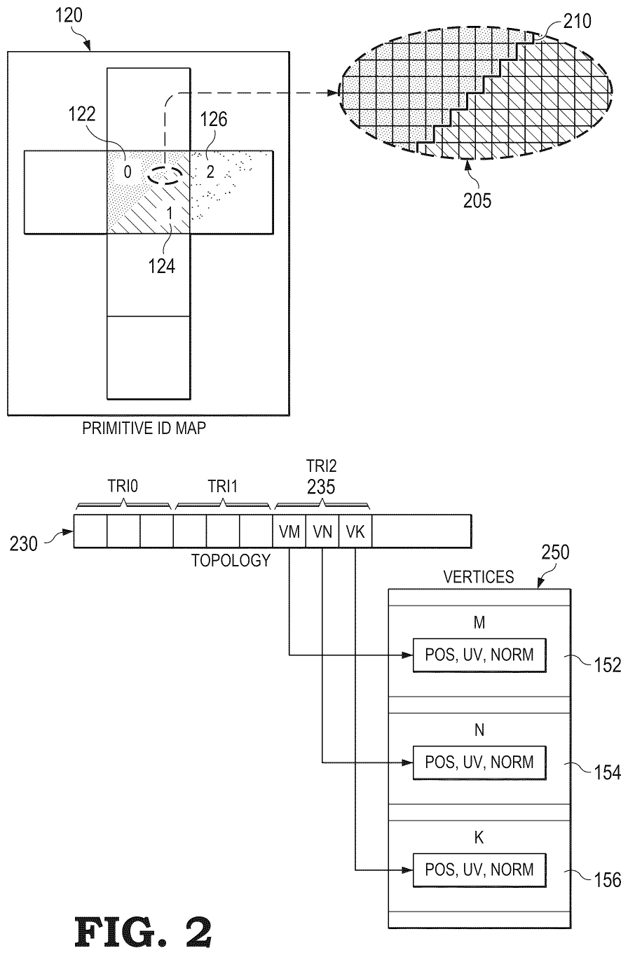

FIG. 2 continues the example of FIG. 1, and again includes primitive ID map 120 and triangle primitives 122, 124, 126. An expanded portion 205 of the primitive ID map 120 focuses on the junction between triangle primitives 122 and 124, each positioned to occupy half of the front-facing face of cube object 105. The border 210 between these primitives has a jagged appearance, illustrating aliasing issues common to bitmap diagonals. This visual representation highlights the large memory footprint inherent in utilizing such primitive ID maps. Unlike rendering operations in which pixels may be assigned interpolated color values to mitigate aliasing effects, no interpolation is possible when determining a pixel's location in terms of primitive identification—e.g., when determining a location of a pixel, there is no interpolation possible between primitives 0 and 1, since such interpolation would likely result in a false indication that a pixel is ostensibly located in primitive 0.5 (which does not exist). This issue typically necessitates a high resolution in the primitive ID map to avoid misidentification, resulting in significant memory requirements.

In addition to the primitive ID map 120, FIG. 2 includes a topology table 230 and a vertices table 250. The topology table 230 includes a listing of each primitive's vertices, such that based on any given point's UV coordinates within the primitive ID map 120, the corresponding primitive containing that point may be identified. As an example, the location of point 108 (with reference to FIG. 1) lies within the boundary defined by each vertex of vertices 235 (M, N, K), which are those (as indicated within topology table 230 via the UV coordinates represented as vM, vN, vK) that are associated with triangle primitive 126. The vertices table 250 comprises a listing of each vertex within the rendering space, including (in the depicted example of FIG. 2) information for each vertex regarding its 3D position in the rendering space, UV coordinates for the vertex in the corresponding texture map (e.g., texture map 110 of FIG. 1), and the surface normal associated with the vertex.

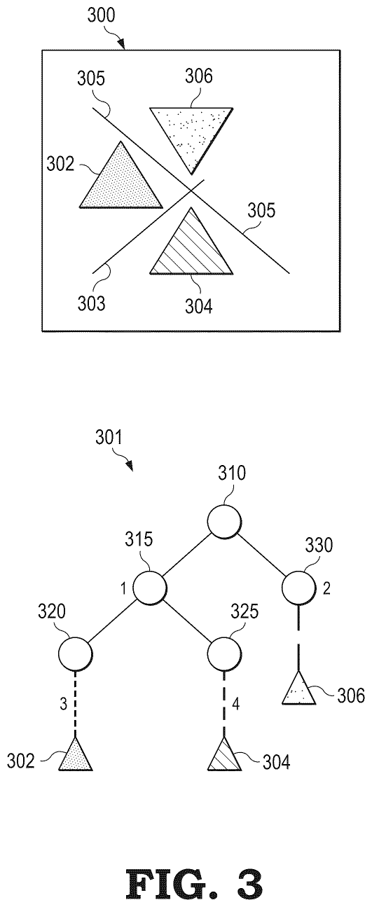

FIG. 3 illustrates an example of binary space partitioning (BSP) for organizing and managing primitives within the UV space of a primitive ID map, as used in one or more previous approaches.

The top portion of FIG. 3 depicts a 2D representation of three primitives 302, 304, and 306 within the UV space 300 of a primitive ID map (such as may be similar to primitive ID map 120 of FIGS. 1 and 2). The UV space 300 is divided by a first partition line 305 and a second partition line 303. These partition lines 305, 303 separate the primitives into distinct regions of the encompassing UV space 300. In particular, a first partition line 305 creates separate primitive 306 from a group of primitives 302, 304. A second partition line 303 divides that group into a first partition comprising primitive 302 and a second partition comprising primitive 304. This division is intended to facilitate the organization and management of the primitives within the UV space 300.

The bottom portion of FIG. 3 depicts a binary tree structure 301 representing the UV space 300. The root node 310 represents the initial partitioning decision, which splits the UV space using the first partition line 305. This root node branches into child nodes 315 and 330, each representing further subdivisions of the UV space. As used herein, a child node refers to a node in which further partitioning is defined, representing intermediate levels in the binary tree structure 301. In the depicted example, child node 315 corresponds to the left side of the first partition line 305, while child node 330 corresponds to the right side. The child nodes further branch into additional nodes 320 and 325, representing subsequent partitioning decisions. Node 320 corresponds to the left side of the second partition line 303, and node 325 corresponds to the right side. As used herein, a leaf node refers to a node that represents a final level of partitioning, corresponding to specific graphical primitives within the clusters and containing the actual primitive data or its reference. In the depicted example, each leaf node in the binary tree corresponds to a single primitive. For example, leaf node 320 corresponds to primitive 302, node 325 corresponds to primitive 304, and node 330 corresponds to primitive 306.

In this BSP approach, each node in the binary tree stores the line equation of the partitioning line, and each leaf node stores the index of the primitive. This results in significant storage requirements, especially when dealing with large numbers of primitives. The need to store line equations and primitive indices for each node leads to high memory usage, making this approach inefficient for handling complex 3D objects with thousands of primitives or more.

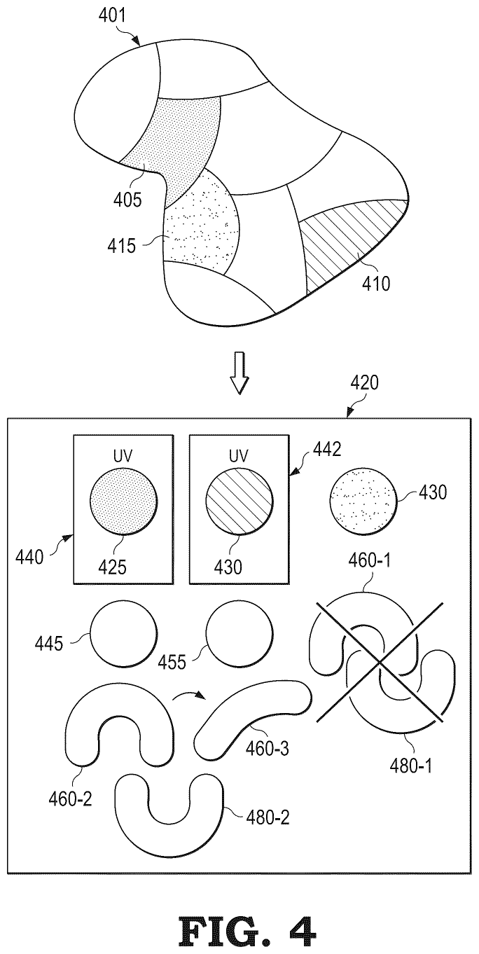

FIG. 4 illustrates aspects of organizing and managing primitives within a virtual UV space (also referred to as a shade space), in accordance with one or more embodiments.

The top portion of FIG. 4 shows a 3D object 401, with its surface divided into multiple clusters, such as clusters 405, 410, and 415. This division into clusters is based on the geometry of the object, with each cluster containing a manageable number of primitives. In various embodiments, the quantity of primitives within each cluster may be limited for purposes of memory optimization and search efficiency. For example, in certain embodiments, each cluster associated with the 3D object 301 is limited to a finite quantity of primitives, such as a finite quantity ranging from 128 to 256. However, it will be appreciated that in various embodiments any quantity limitation (or none) may be selected.

The bottom portion of FIG. 4 introduces a virtual UV space 420 used for decoupled shading, which is distinct from the UV space used in texturing. This decoupled virtual UV space is used for referencing shaded samples. In certain scenarios and embodiments, this decoupled virtual UV space corresponds to a primitive ID map. In the depicted embodiment, the clusters from the 3D object 401 are unwrapped and mapped, such that the unwrapped clusters 425, 435, and 430 respectively correspond to the clusters 405, 410, and 415. Virtual UV spaces 440 and 442 indicate the respective bounds of a separate virtual UV space for each of unwrapped clusters 445 and 430, which are positioned, aligned and scaled within the virtual UV space.

In one example of non-optimal positioning, unwrapped clusters 460-1 and 480-1 illustrate an overlapping arrangement in which no partitioning line can be drawn between them, leading to inefficient organization and potential rendering artifacts. In contrast, clusters 460-2 and 480-2 are positioned within the virtual UV space 420 in a manner facilitating partition, ensuring no overlap and allowing a separate virtual UV space for each such unwrapped cluster (e.g., virtual UV spaces 440 and 442). Cluster 460-3 is shown as a version of the cluster 460 that has been flattened, such as to optimize its placement within the virtual UV space. Generally, UV parametrization of geometry (e.g., flattening) considers geometry topology, coplanarity of the geometry faces, surface area and other heuristics. In certain embodiments, vertex positions in UV space are snapped to a grid to be accurately quantized during spatial structure build process. For example, small primitives are resized via quantization in order to be fully represented, with parameterized UV islands comprising a cluster being placed such that geometry splitting is minimized during space partitioning. Thus, in some embodiments, the unwrapped UV islands comprising a cluster are arranged and partitioned in a manner that avoids intersection and minimizes the number of bisections required, enhancing the efficiency of the process.

These embodiments leverage optimized placements and partitioning within the UV space 420 to improve the overall efficiency of the shading process. By using a large virtual UV space for representing primitive mapping, the techniques avoid the storage inefficiencies and rendering artifacts associated with traditional primitive ID maps.

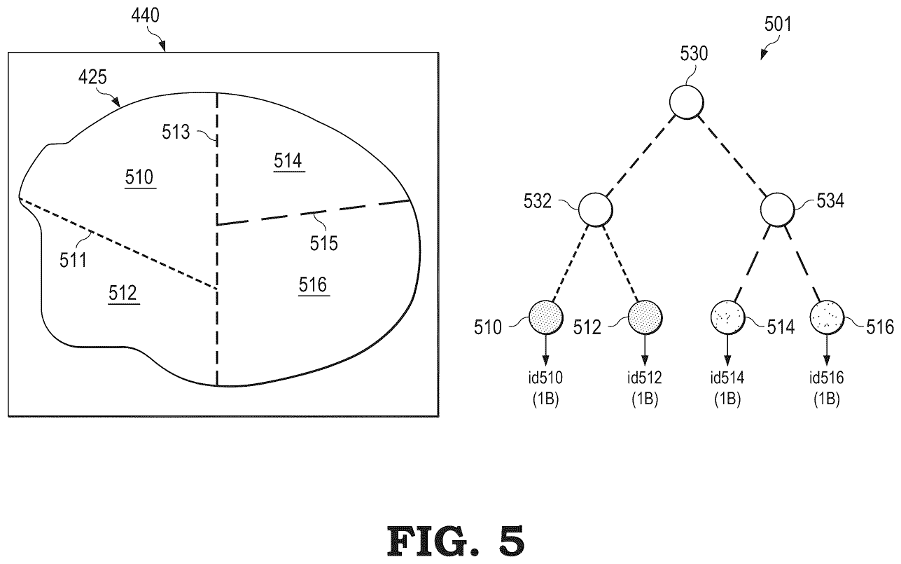

FIG. 5 illustrates aspects of the partitioning and encoding process within the individual virtual UV space 440 containing the unwrapped cluster 425, in accordance with one or more embodiments.

The left side of FIG. 5 shows the unwrapped cluster 425 from FIG. 4, further subdivided into partitioned clusters within its UV space 440. The hierarchical partitioning process begins with partition dividing line 513, which separates the UV space 440 into two primary regions. These primary regions are then further subdivided: the region on the left side of partition dividing line 513 is partitioned by partition dividing line 511, creating distinct regions 510 and 512. Similarly, the region on the right side of partition dividing line 513 is partitioned by partition dividing line 515, creating distinct regions 514 and 516. This hierarchical approach of recursively subdividing the space ensures an organized partitioning of the unwrapped cluster 425 into the distinct regions or partitions 510, 512, 514, and 516.

The right side of FIG. 5 depicts a corresponding treelet structure 501 used to manage and encode the partitioned unwrapped cluster 425. A root node 530 of the treelet structure 501 represents the initial partitioning, which splits the UV space in a manner corresponding to the partition dividing line 513. The treelet structure 501 branches to child nodes 532 and 534, which represent further subdivisions (respectively corresponding to partition dividing lines 511 and 515) of the unwrapped cluster 425.

The treelet structure 501 continues to divide the UV space 440, with child node 532 further branching into leaf nodes (also termed leaves) representing partitions 510 and 512, and node 534 branching into leaf nodes representing partitions 514 and 516. In this manner, each leaf node 510, 512, 514, 516 corresponds to the similarly referenced region within the UV space 440.

The arrows leading down from these leaf nodes indicate the mapping process from the partitioned clusters to specific identifiers (e.g., id510, id512, id514, id516) that correspond to their positions within the UV space 440. Given the relatively low primitive quantity limit noted earlier (e.g., a limitation of 256 primitives per cluster), in the depicted embodiment, the memory required to store each identifier is limited to a single byte.

In certain embodiments, a global primitive ID is provided by utilizing cluster offsets, enabling a unique identifier for each primitive within the entire UV space, even when that UV space is divided into smaller clusters for processing.

For example, each cluster is assigned an offset value, which serves as a unique identifier for that cluster within the global context of the UV space. This offset is added to the local primitive IDs within the cluster to generate a global primitive ID. Within each cluster, primitives are assigned local IDs, which are unique only within the context of that cluster. To calculate the global primitive ID for a given primitive, the local ID of the primitive is combined with the cluster offset. This ensures that even if different clusters have overlapping local IDs, the global IDs remain unique. During the encoding process, the local primitive IDs are stored along with their respective cluster offsets. When a primitive needs to be referenced or processed globally, its global ID is computed by adding the cluster offset to its local ID. In this manner, the system preserves the uniqueness of each primitive across the entire UV space.

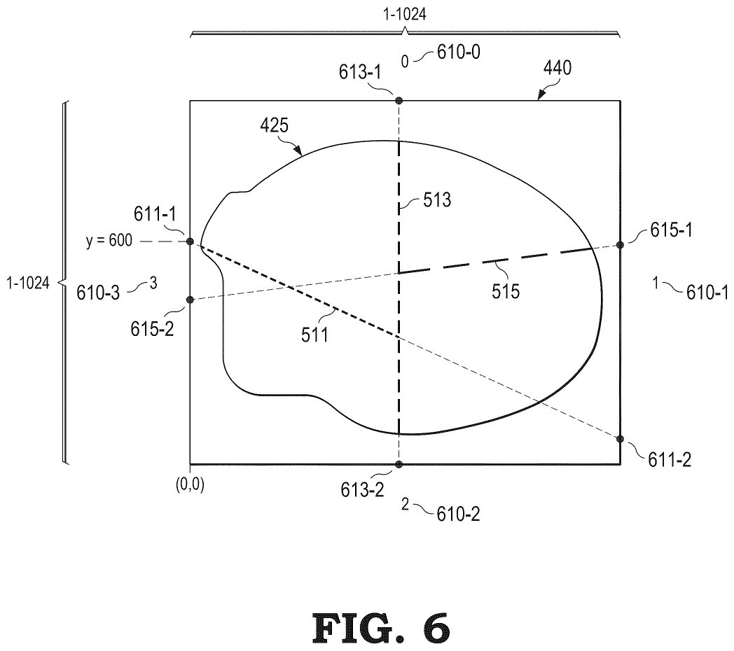

FIG. 6 illustrates an encoding approach used to encode a partitioned cluster-specific UV space 440, in accordance with one or more embodiments.

The UV space 440 containing the unwrapped cluster 425 is again partitioned into distinct regions by partition dividing lines 511, 513, and 515, as described elsewhere herein with respect to FIG. 5. Each partition dividing line 511, 513, and 515 is extended to intersect the bounds of the UV space 440 at their respective endpoints, which are used for encoding purposes. In particular, in the depicted example, partition dividing line 511 intersects the bounds of the UV space 440 at endpoints 611-1 and 611-2; partition dividing line 513 intersects the bounds of the UV space 440 at endpoints 613-1 and 613-2; and partition dividing line 515 intersects the bounds of the UV space 440 at endpoints 615-1 and 615-2.

The UV space 440 is also divided into a 1 k-coordinate space (1024×1024), providing a high-resolution grid for encoding the positions of the partition dividing lines. For each endpoint, the encoding process involves storing the side identifier 610 (610-0 at the top, 610-1 at the right, 610-2 at the bottom, and 610-3 at the left) and the endpoint's coordinate along that side. For example, endpoint 611-1 is encoded is encoded via its coordinate y=600 along the left side (side identifier 610-3). While the respective coordinates for the other endpoints are omitted for clarity, they are encoded similarly: e.g., endpoint 613-1 is encoded via its x coordinate along the top side (side identifier 610-0); endpoints 615-1 and 611-2 are each encoded via their respective y coordinates along the right side (side identifier 610-1); endpoint 613-2 is encoded via its x coordinate along the bottom side (side identifier 610-2); and endpoint 615-2 is encoded via its y coordinate along the left side (side identifier 610-3). It will be appreciated that although the UV space 440 is divided into a 1 k-coordinate space, any coordinate resolution may be selected for the encoding process.

The depicted encoding method allows for a compact and efficient representation of the partitioning information within the UV space 440. By using side identifiers and coordinates, the positions of the partition dividing lines can be accurately and efficiently stored and retrieved during the rendering process. However, in various embodiments and scenarios, it introduces discrepancies between ideal partition dividing lines and actual partition dividing lines due to the quantized coordinate system.

In various embodiments, alternative encoding schemes may be utilized, including as non-limiting examples: hierarchical bounding volumes, in which each partition is represented by a bounding volume with coordinates and hierarchical levels; delta encoding, in which only the differences between successive partitioning decisions are stored to reduce data size; and run-length encoding (RLE), which encodes stretches of the UV space with similar partitioning characteristics to achieve efficient compression.

This hierarchical encoding ensures that the mapping of the virtual UV space can be efficiently managed and traversed during the rendering process. By using this encoding mechanism, the described techniques avoid storage-heavy methods associated with primitive ID maps, reducing memory usage and improving rendering performance. Moreover, the compact encoding provides that even with a large number of primitives, associated storage requirements remain minimal, reducing memory usage relative to previous approaches.

While the encoding system described in FIG. 6 provides a compact and efficient representation of partitioned UV space, it can introduce discrepancies between ideal partition dividing lines and actual partition dividing lines due to the quantized coordinate system. These differences may cause issues in accurately assigning primitives to their correct partitions, leading to potential rendering artifacts and inefficiencies. Another potential negative effect of mismatch between partition lines and primitive edges is generation of thin “splinter” primitives. To address these challenges, certain embodiments utilize extrapolation and validation of primitive attributes to reduce the appearance of aliasing artifacts that might otherwise result from the discrepancies between the ideal and actual partitioning lines. In certain embodiments, partition line fitting is performed to the appropriate edges and UV parametrization is adjusted to minimize the extrapolation errors and generation of splinter primitives, such as via statistical optimization techniques.

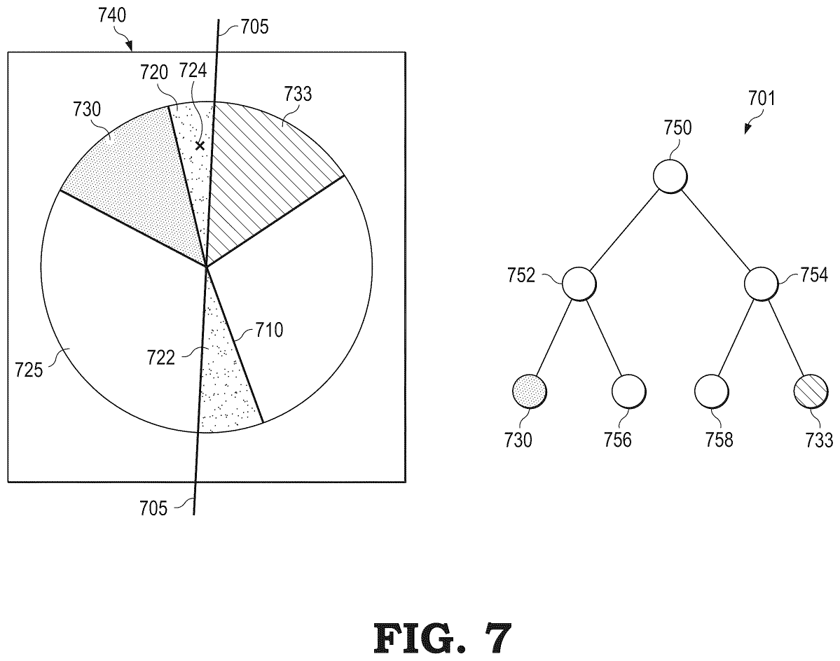

FIG. 7 illustrates the use of filtering and extrapolation to mitigate potential aliasing artifacts that might otherwise result from discrepancies between ideal partition dividing lines and actual partition dividing lines, in accordance with one or more embodiments.

The left side of FIG. 7 depicts a UV space 740 containing an unwrapped cluster 725. An ideal partition line 710 represents the optimal division of the UV space, while the actual partitioning line 705 is the result of the quantized coordinate system used for encoding. This quantization leads to substantially triangular regions 720 and 722, which are located between the ideal partition line 710 and the actual partitioning line 705.

In certain embodiments, the regions 720 and 722 of the unwrapped cluster 725 are filtered (e.g., discarded or ignored) as undesirable splinter primitives because they represent inaccuracies introduced by the quantized coordinate system. By filtering these small, thin regions based on size, shape, and alignment with the overall geometry, the filtering process helps maintain the efficiency and accuracy of the rendering process. Additionally, such filtering allows for extrapolation of attributes from neighboring primitives, ensuring continuity and reducing visual artifacts. In such embodiments, primitives located in those regions may nonetheless be assigned to validly partitioned regions that can be processed by the rendering pipeline without causing artifacts or inefficiencies, as described below with respect to an example primitive 724.

The primitive 724 is located within the region 720, and in the depicted embodiment is therefore to be assigned to one of the neighboring partitioned regions 730 and 733. This determination is achieved by extrapolating the position of the primitive 724 to one of valid neighboring partitioned regions 730 and 733 using the treelet structure 701, which corresponds to the partitioning of the UV space 740. The root node 750 of the treelet structure 701 represents the initial partitioning decision, which splits the UV space 740 using the actual partition dividing line 705. The treelet branches into child nodes 752 and 754 that further subdivide the UV space 740, with leaves 730 and 733 corresponding to the similarly referenced regions of the UV space 740, and with leaves 756 and 758 representing regions of the UV space 740 that have been omitted for clarity.

In various embodiments, the process of assigning primitive 724 to one of the neighboring regions over another (e.g., assigning the primitive 724 to region 730 rather than region 733) is determined by the search traversal of the treelet structure 701. For example, in certain embodiments and scenarios the search traversal process may evaluate one or more criteria at each node to determine which child node is next traversed. As non-limited examples, such criteria may include one or more of the spatial position of the primitive relative to the partition dividing lines, the quantized coordinates of the primitive, a predefined traversal order (e.g., always traversing left before right if criteria are equal), experiential heuristics, and/or other traversal criteria. In some embodiments, such traversal criteria are encoded within one or more of the treelet nodes 750, 752, 754.

In certain embodiments, partitioning lines are quantized and encoded in a treelet node, along with other relevant information. The leaf nodes of the tree store some number of triangle IDs (e.g. up to four) which is controlled by split heuristics and other parameters, while internal tree nodes store encoded references to other nodes. The tree information is compactly stored for GPU-friendly tree traversal. For example, in some embodiments the references to triangles are stored in order according to their probabilities of being tested during traversal. In another example, nodes may be ordered for storage in a manner that increases access locality of the nodes that are more likely to be traversed together.

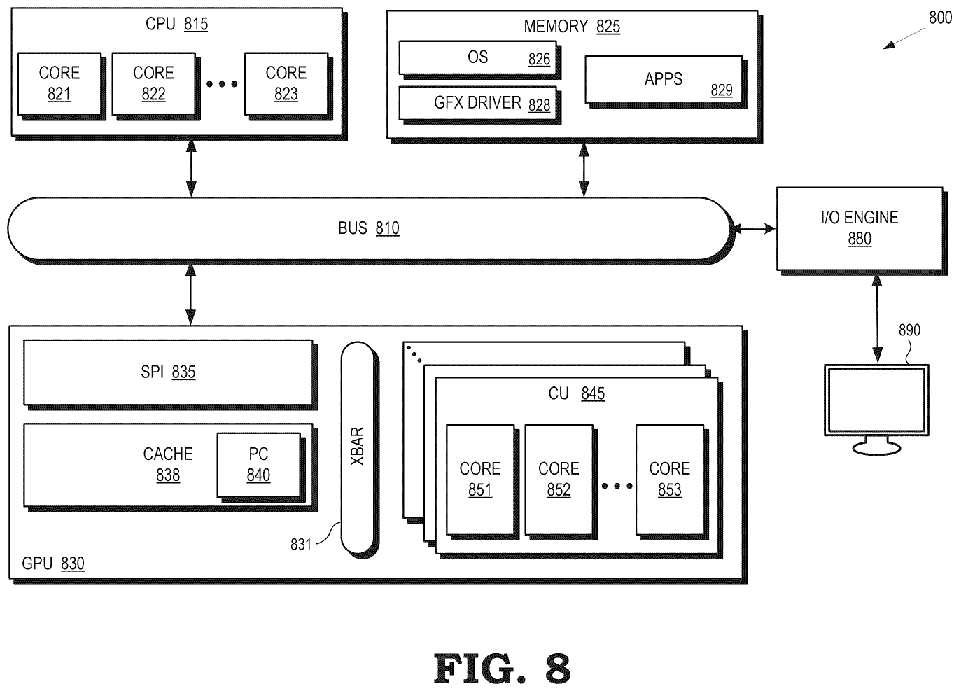

FIG. 8 is a block diagram of a processing system 800 implementing one or more embodiments. For example, in certain embodiments and scenarios, the processing system 800 performs one or more operations to partition a surface of a 3D object into multiple clusters, map each cluster to a respective virtual UV space, hierarchically partition the virtual UV space, and encode partitioning information based on the hierarchical partitioning, such as for use in rendering the multiple clusters for display based at least in part on that encoded partitioning information.

The processing system 800 comprises a central bus 810 facilitating communication between the various components of the system, such as by enabling efficient data exchange and synchronization between different processing units (e.g., CPU 815 and GPU 830), memory components (e.g., memory 825), and input/output mechanisms (e.g., I/O engine 880). Various embodiments of the processing system 800 include other buses, bridges, switches, routers, and the like, which are not separately shown in FIG. 8 in the interest of clarity.

The bus 810 is communicatively coupled to a central processing unit (CPU) 815, which orchestrates the overall operations of the processing system 800. The CPU 815 includes multiple processor cores 821-823, allowing it to execute several tasks concurrently (in parallel). These processor cores 821-823 are responsible for executing the primary software instructions, including system-level operations, application processes, and certain graphics-related functions. In some embodiments, one or more of the processor cores 821-823 each operate to perform the same operation(s) on different data sets (e.g., via Single Instruction Multiple Data or SIMD processing). Though in the example embodiment illustrated in FIG. 8, three processor cores 821-823 are depicted to represent an arbitrary M number of cores, the number of processor cores 821-823 implemented in the CPU 815 is a matter of design choice. As such, in other embodiments, the CPU 815 can include any number of processor cores 821-823. The processor cores 821-823 execute instructions such as program code 825 stored in the memory 825 and the CPU 815 stores information in the memory 825 such as the results of the executed instructions. The CPU 815 is also able to initiate graphics processing by issuing draw calls to the GPU 830.

An input/output (I/O) engine 880 communicatively couples the processing system 800 to external devices and peripherals such as keyboards, mice, printers, external disks, and the like. One such device connected to the I/O engine 880 is the display 890, which visually presents the graphics and other visual content processed by the processing system 800, including the rendering of 3D surfaces that comprise multiple graphical primitives.

A memory 825 is also communicatively coupled to the bus 810 and serves as the main data storage for the processing system 800 using a non-transitory computer-readable medium such as a dynamic random-access memory (DRAM). However, in various embodiments, the memory 825 is implemented using other types of memory including, for example, static random-access memory (SRAM), nonvolatile RAM, and the like. In the depicted embodiment, the memory 825 stores some or all of an operating system (OS) 826, which oversees and manages hardware resources; a graphics driver 828, which provides a bridge between software applications and the GPU 830, translating application requests into hardware-level operations; and applications 829, which include various software programs that might be run by the user, some of which may generate graphical data or tasks that utilize one or more facilities of the GPU 830.

Techniques described herein are, in various embodiments, employed at least in part by the GPU 830. The GPU 830 includes, for example, any of a variety of parallel processors, vector processors, coprocessors, accelerated processing units (APUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The GPU 830 handles specialized graphics and computation tasks, offloading such functions from the CPU 815. For example, the GPU 830 renders objects (e.g., groups of primitives) according to one or more shader programs to produce values of pixels that are provided to the display 890, which uses the pixel values to display an image that represents the rendered objects.

To render the objects, the GPU 830 implements a plurality of compute units 845 that execute instructions concurrently or in parallel from, for example, one or more applications 829. For example, the GPU 830 executes via the compute units 845 instructions from a shader program, raytracing program, graphics pipeline, or the like using a plurality of GPU cores 851-853 to render one or more objects. A crossbar 831 ensures efficient data flow between the compute units 845 and other components of the GPU 830, such as to facilitate the processing of partitioned clusters and the traversal of encoded hierarchical data structures during rendering.

The GPU 830 utilizes the plurality of compute units 845 for processing graphics tasks and computation tasks of the GPU 830 in parallel. In some embodiments, the CPU 815 and the GPU 830 have an equal number of processing cores, while in other embodiments, the CPU 815 and the GPU 830 have a different number of processing cores. In the depicted embodiment of FIG. 8, three GPU cores 851-853 are presented representing an arbitrary N number of GPU cores, with those GPU cores 851-853 being organized by and associated with each of an arbitrary number of compute units (CUs) 845.

Each CU 845 contains multiple GPU cores 851-853, which handle various tasks such as vertex shading, pixel shading, and other graphics-related computations. In various embodiments, the number of compute units 845 and their respectively associated GPU cores 851-853 may be selected as a matter of design choice. Thus, in other implementations, the GPU 830 can include any number of compute units 845 and/or processor cores 851-853. Some implementations of the GPU 830 are used for general-purpose computing. The GPU 830 executes instructions such as program code (e.g., shader code, raytracing code) included in one or more of the applications 829 (e.g., shader programs, raytracing programs) stored in the memory 825, and the GPU 830 stores information in the memory 825 such as the results of the executed instruction. In the depicted embodiment, the memory 825 further includes some or all of an operating system (OS) 826, such as to provide an interface between the applications 829 and the graphics driver 828.

In the depicted embodiment, operations of the GPU 830 are managed by the Shader Processor Input (SPI) 835. The SPI 835 comprises scheduling circuitry that determines how tasks are allocated among the compute units (CUs) 845. For example, the SPI 835 is responsible for managing and scheduling the execution of a list of commands sent to the GPU 830 for processing. These commands are typically a sequence of low-level instructions that specify various operations, ranging from drawing primitives and setting colors to updating textures. Each graphical primitive is at least partially defined by its vertices, each of which identifies a point in 3D space and may also include additional associated data like color, texture coordinates, normals, and other attributes critical for rendering. Each vertex's associated data or attributes are stored in the Parameter Cache (PC) 840. In the depicted embodiment, a cache 838 stores partitioning and shading information.

The GPU 830, via the compute units 845 and cores 851-853, performs partitioning and mapping operations, utilizing the SPI 835 for task scheduling and the PC 840 for storing attributes of the graphical primitives. The SPI 835 operates to execute the received graphical instructions in the correct order and that any needed data from PC 840 are available for decoding the commands and translating those commands into the appropriate hardware instructions for execution by one or more CUs of the plurality of compute units 845.

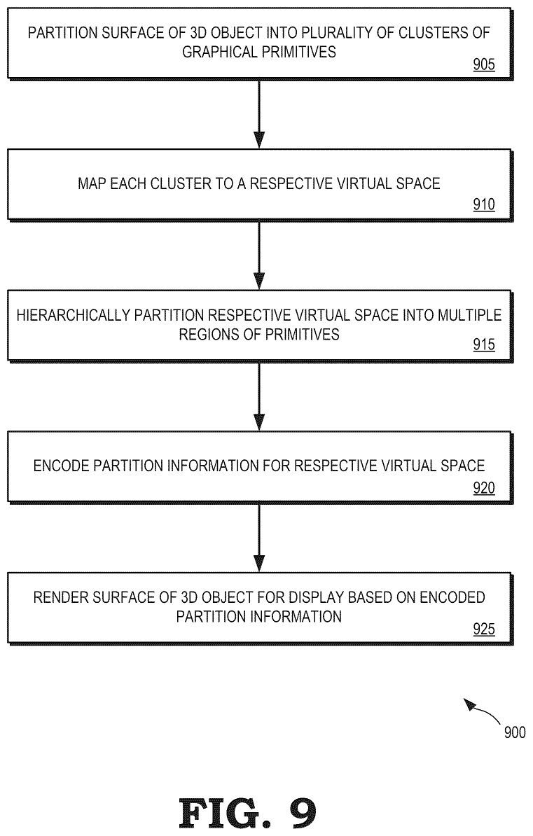

FIG. 9 is a flow diagram illustrating an operational routine 900 for rendering a surface of a three-dimensional (3D) object for display using hierarchical partitioning and encoding techniques described herein, in accordance with one or more embodiments. The routine 900 may be performed, for example, by a processing system such as processing system 800 and/or GPU 830 of FIG. 8.

The routine 900 begins at 905, in which the processing system partitions the surface of a 3D object into a plurality of clusters, with each cluster comprising a quantity of graphical primitives. This partitioning facilitates efficient management and processing of the graphical primitives by organizing them into smaller, more manageable clusters. The routine proceeds to 910.

At 910, the processing system maps each cluster of the plurality of clusters to a respective virtual space. In certain embodiments, such mapping comprises assigning a dedicated virtual space (e.g., a UV space) to each cluster. The virtual space serves as a framework for further partitioning and encoding operations. The routine proceeds to 915.

At 915, the respective virtual space is hierarchically partitioned into multiple regions and geometry is parameterized into virtual UV space, with each region within the virtual UV space comprising one or more graphical primitives of the 3D object surface. The hierarchical partitioning divides the virtual space into progressively smaller regions, facilitating efficient encoding and retrieval of partition information as part of the rendering process. The routine proceeds to 920.

At 920, partition information for the respective virtual space is encoded based on the hierarchical partitioning. The encoding process captures the structure and boundaries of the partitions within the virtual space, generating a data representation that enables efficient storage and retrieval of partition information. This encoded partition information is used to facilitate the rendering process. The routine proceeds to 925.

At 925, the surface of the 3D object is rendered for display based at least in part on the encoded partitioning information. The rendering process leverages the encoded partition information to accurately and efficiently determine shading and other visual properties for the graphical primitives, resulting in the display of the rendered surface on an output device (e.g., display 890 of FIG. 8).

In some embodiments, the apparatus and techniques described above are implemented in a system including one or more integrated circuit (IC) devices (also referred to as integrated circuit packages or microchips), such as the operations, systems, and techniques described above with reference to FIGS. 1-9. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
partitioning a surface of a three-dimensional (3D) object into a plurality of clusters, each cluster comprising a quantity of graphical primitives;
mapping each cluster of the plurality of clusters to a respective virtual space;
for at least one cluster of the plurality of clusters:
hierarchically partitioning the respective virtual space for the at least one cluster into multiple regions, each region comprising one or more graphical primitives of the at least one cluster; and
encoding partition information for the respective virtual space based on the hierarchical partitioning; and
rendering the surface of the 3D object for display based at least in part on the encoded partitioning information.

2. The method of claim 1, wherein partitioning the surface into the plurality of clusters comprises limiting each cluster of the plurality of clusters to an indicated quantity of graphical primitives.

3. The method of claim 2, wherein the indicated quantity comprises between 128 and 256 graphical primitives, inclusive.

4. The method of claim 1, wherein partitioning the respective virtual space for the at least one cluster comprises assigning a quantized coordinate system to the respective virtual space.

5. The method of claim 1, wherein encoding the partition information for the respective virtual space comprises generating a hierarchical data structure representing the hierarchical partitioning of the respective virtual space.

6. The method of claim 5, wherein generating the hierarchical data structure comprises encoding multiple levels of the hierarchical partitioning as a single node of the hierarchical data structure.

7. The method of claim 6, wherein encoding the multiple levels comprises encoding, as part of the single node of the hierarchical data structure:
information identifying a partition divider for the at least one cluster; and
information identifying a graphical primitive of the at least one cluster.

8. The method of claim 5, wherein rendering the plurality of clusters for display comprises determining shading information for the at least one cluster based on the encoded hierarchical data structure.

9. The method of claim 1, wherein hierarchically partitioning the respective virtual space includes determining at least one partition divider for the at least one cluster that defines a border between two of the multiple regions, and wherein encoding the partition information comprises encoding information identifying an intersection of the at least one partition dividing line with a boundary of the respective virtual space.

10. The method of claim 1, wherein:
hierarchically partitioning the respective virtual space for the at least one cluster comprises determining a partition divider for the at least one cluster; and
encoding the partition information for the respective virtual space based on the hierarchical partitioning comprises discarding partition information for at least one region of the multiple regions, the at least one region being positioned between the determined partition divider and a quantized representation of the determined partition divider in the respective virtual space.

11. The method of claim 10, wherein encoding the partition information for the respective virtual space comprises assigning each graphical primitive of the at least one region to a distinct other of the multiple regions, the distinct other region being adjacent to the at least one region in the respective virtual space.

12. A system comprising:
a processor configured to partition a surface of a three-dimensional (3D) object into a plurality of clusters, each cluster comprising a quantity of graphical primitives;
a memory coupled to the processor, the memory storing instructions executable by the processor to map each cluster of the plurality of clusters to a respective virtual space;
wherein the processor is further configured to:
hierarchically partition the respective virtual space for at least one cluster of the plurality of clusters into multiple regions, wherein each region comprises one or more graphical primitives of the at least one cluster;
encode partition information for the respective virtual space based on the hierarchical partitioning; and
render the surface of the 3D object for display based at least in part on the encoded partitioning information.

13. The system of claim 12, wherein to partition the surface into the plurality of clusters includes to limit each cluster of the plurality of clusters to an indicated quantity of graphical primitives.

14. The system of claim 12, wherein to partition the respective virtual space for the at least one cluster comprises assigning a quantized coordinate system to the respective virtual space.

15. The system of claim 12, wherein to encode the partition information for the respective virtual space comprises to generate a hierarchical data structure representing the hierarchical partitioning of the respective virtual space.

16. The system of claim 15, wherein to generate the hierarchical data structure comprises to encode multiple levels of the hierarchical partitioning as a single node of the hierarchical data structure.

17. The system of claim 16, wherein to encode the multiple levels comprises to encode, as part of the single node of the hierarchical data structure:
information identifying a partition divider for the at least one cluster; and
information identifying a graphical primitive of the at least one cluster.

18. The system of claim 15, wherein to render the plurality of clusters for display comprises to determine shading information for the at least one cluster based on the encoded hierarchical data structure.

19. The system of claim 12, wherein to hierarchically partition the respective virtual space includes to determine at least one partition divider for the at least one cluster that defines a border between two of the multiple regions, and wherein to encode the partition information comprises to encode information identifying an intersection of the at least one partition dividing line with a boundary of the respective virtual space.

20. A non-transitory computer-readable medium storing instructions that, when executed by one or more processors, cause the one or more processors to:
partition a surface of a three-dimensional (3D) object into a plurality of clusters, each cluster comprising a quantity of graphical primitives;
map each cluster of the plurality of clusters to a respective virtual space;
for at least one cluster of the plurality of clusters:
hierarchically partition the respective virtual space for the at least one cluster into multiple regions, each region comprising one or more graphical primitives of the at least one cluster; and
encode partition information for the respective virtual space based on the hierarchical partitioning; and
render the surface of the 3D object for display based at least in part on the encoded partitioning information.
